(19) United States
(12) Patent Application Publication
(10) Pub. No.: US 2023/0188569 A1
(43) Pub. Date: Jun. 15, 2023

(54) PROACTIVE USER SAFEGUARDS FOR SMART ENVIRONMENTS

(71) Applicant: International Business Machines Corporation, Armonk, NY (US)

(72) Inventors: Atul Mene, Morrisville, NC (US); Tushar Agrawal, West Fargo, ND (US); Jeremy R. Fox, Georgetown, TX (US); Sarbajit K. Rakshit, Kolkata (IN)

(21) Appl. No.: 17/550,314

(22) Filed: Dec. 14, 2021

(51) Int. Cl. H04L 9/40; G06N 20/00

(52) U.S. Cl. CPC H04L 63/20; H04L 63/102; G06N 20/00

(57) ABSTRACT

A processor may collect smart environment information associated with a user and the smart environment. A processor may analyze the smart environment information and a security policy having one or more security rules, for one or more environment conditions associated with the smart environment from the smart environment information. A processor may determine an impact level associated with the user and the one or more environment conditions. A processor may evaluate the user based on the impact level and the security policy.

### BACKGROUND

The present disclosure relates generally to the field of artificial intelligence (AI), and more particularly to the field of smart environments.

Computing devices or other smart devices have evolved over time to accomplish various tasks for humans, making our lives easier. Such devices can be configured to link and communicate with other smart devices within an environment (e.g., smart environment). By combining smart devices with AI and machine learning capabilities, smart environments can be configured within user's homes, offices, building, etc. These smart environments can be configured to perform various services or to assist users with various task (e.g., scheduling). As these devices have grown in popularity, so too have their usefulness and their ability to enhance users' daily experience.

### SUMMARY

Embodiments of the present disclosure include a method, computer program product, and system for managing user access to a smart environment. A processor may collect smart environment information associated with a user and the smart environment. A processor may analyze the smart environment information and a security policy having one or more security rules, for one or more environment conditions associated with the smart environment from the smart environment information. A processor may determine an impact level associated with the user and the one or more environment conditions. A processor may evaluate the user based on the impact level and the security policy.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of an embodiment of a smart environment access management system, in accordance with the present disclosure.

FIG. 2 illustrates a flowchart of a method for managing access to a smart environment, in accordance with embodiments of the present disclosure.

FIG. 3A illustrates a cloud computing environment, in accordance with embodiments of the present disclosure.

FIG. 3B illustrates abstraction model layers, in accordance with embodiments of the present disclosure.

FIG. 4 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relates generally to the field of artificial intelligence (AI), and more particularly to the field of smart environments, such as workplaces. While the present disclosure is not necessarily limited to such applications, various aspects of the disclosure may be appreciated through a discussion of several examples using this context.

The potential hazards associated with various workplace varies dramatically depending on the actions performed within a particular work area and the particular user or users occupying the workspace. Though many workplaces and their conditions may incur little change over time and remain static, other workplaces, by their very nature, have conditions that dynamically change overtime. Depending on the workplace, such conditions may result from changes in weather, changes in equipment conditions (e.g., broken or damaged machine, loss of power, etc.) and changes in the number of people within the environment. While many of these conditions may be benign to employees or users within the workspace, some environmental conditions can negatively impact users. Such negative effects may range in impact level from mere user annoyance to potentially hazardous conditions that result in elevated risk levels to users. Particularly, elevated risk levels may result if the user is unaware of the potentially hazardous environmental condition prior to entering the workspace.

For example, a miner (e.g., user) may arrive at the entrance to a mine (e.g., workplace) for the beginning of their workday. Many health and safety protocols have been developed over the years to make the naturally hazardous industry safer for miners while they perform their mining duties. Despite such health and safety protocols, the inherent properties associated with mining can result in changing conditions that, if a miner is not properly prepared, can result in the miner being negatively affected. For example, if there is a lighting outage within the mine and the miner has forgotten or does not have a light source (e.g., headlamp or flashlight), the miner may be unable to navigate the mine or perform their duty within the mine without a proper light source. As such, a miner may have to leave the mine to retrieve a flashlight before entering the mine or may have to shelter in place until another miner can reach them and either direct the unprepared miner to an extra light sources or help them navigate to a portion of the mine not affected by the lighting outage. While this example where the miner was unaware of the lighting outage (e.g., environment condition) within a mine may be more of an annoyance to the overall mining (e.g., workplace) workflow other conditions, such as possible flooding within the mine, may require a miner to be prepared and/or aware for the condition prior to entering the mine. As such, there is a desire to proactively mitigate the potential impact of environment conditions on users within a smart environment (e.g., workplace) by managing user access to the smart environment.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

It will be readily understood that the instant components, as generally described and illustrated in the Figures herein, may be arranged and designed in a wide variety of different configurations. Accordingly, the following detailed description of the embodiments of at least one of a method, apparatus, non-transitory computer readable medium and system, as represented in the attached Figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow.

Also, any device depicted in the drawings can be a different device. For example, if a mobile device is shown sending information, a wired device could also be used to send the information. The term “module” may refer to a hardware module, software module, or a module may be a combination of hardware and software resources. Embodiments of hardware-based modules may include self-contained components such as chipsets, specialized circuitry, one or more memory devices and/or persistent storage. A software-based module may be part of a program, program code or linked to program code containing specifically programmed instructions loaded into a memory device or persistent storage device of one or more data processing systems operating as part of the computing environment (e.g., user access management system 100).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application and to enable others of ordinary skill in the art to understand the disclosure for various embodiments with various modifications as are suited to the particular use contemplated.

In embodiments discussed herein, solutions are provided in the form of a method, system, and computer program product, for managing user access to a smart environment, such as a user's workspace. Traditional workspaces often require at least one user to enter the workspace in order to learn that one or more environment conditions within the workspace have changed. While some workspaces may have windows that allow users or employees to inspect an environment most users will be unable to understand the environment conditions of the workspace without first entering the workspace. For example, a researcher (e.g., user) working in a laboratory (e.g., workspace) may be unable to see or know, prior to entering the laboratory, that a hazardous material has been spilled on the laboratory floor, creating a hazardous situation for the researchers entering the workspace. If the researcher were to enter the laboratory without knowing of the hazardous situation, the researcher will likely be unprepared for encountering the hazardous material and as a result, could be harmed. A such, there is a desire to proactively safeguard users intending to enter a workspace (e.g., smart environment) based on one or more conditions.

Embodiments contemplated herein proactively safeguard users intending to enter a smart environment, such as a workspace, by managing user access to the smart environment, based at least in part on a security policy. In embodiments, a processor may observe a user before the user enters a smart environment. The processor may then analyze the smart environment and identify one or more environment conditions within the smart environment that may impact the user upon the user entering the smart environment. While in some embodiments, these environment conditions may have occurred previously within the smart environment, in other embodiments, a processor may identify novel environment conditions within the smart environment. In some embodiments, a security policy may include one or more security rules associated with a one or more particular environment conditions. In embodiments where a processor has identified a novel environment condition, the processor may generate one or more security rules that may be updated to the security policy that reduce the impact level of the environment condition below a safety threshold.

In one example embodiment, a processor may analyze the smart environment and identify that airborne debris are created when a particular machine is used (e.g., an environment condition). A processor may analyze the security policy to determine if the security policy has one or more security rules associated with airborne debris that require a user to perform one or more actions. Continuing this example, a security policy can have a security rule that indicates that in order to reduce the impact of the airborne debris on the user, the user is required to wear protective goggles and a wearable ventilation system in order to enter the smart environment. In embodiments, a processor may evaluate the user (e.g., using environment information) before the user enters or accesses the smart environment to determine if the user has the proper equipment as dictated by the security policy to reduce the impact level of the environment condition on the user. If the processor determines a user does not have the appropriate equipment the impact level of the environment condition on the user is not reduced. The processor may compare and/or analyze the security policy to identify a safety threshold.

In embodiments, the safety threshold may indicate the maximum amount of risk or impact a user may assume when entering the smart environment. In embodiments where a processor determines that the impact level has not been reduced (e.g., the user is not wearing goggles or a mask as required by the security policy), the processor may determine that the impact level activates a safety threshold. Users that activate a safety threshold are identified by the processor as an unapproved accessor and are prevented from accessing the smart environment. In embodiments where the processor determines that the impact level is reduced (e.g., the user is wearing goggles and a mask as required by the security policy), the processor may determine that the impact level does not activate the safety threshold. Users that address the security policy requirements (e.g., security rules) are identified by the processor as approved accessors. Approved accessors may be granted access to the smart environment.

Often, a user may be unaware of a particular environment condition of the smart environment prior to entering the smart environment. For example, the user may not be aware that the machine creating the airborne debris is being used within the smart environment and would not be aware of the need to wear protective goggles or a mask to reduce the impact of the environment condition on them. As such, it would be likely that as the user approaches the smart environment, intending to enter/access the smart environment, would be without the necessary equipment or safeguards dictated by the one or more security rules that would enable the processor to grant the user access to the smart environment (e.g., identify the user as an approved accessor). Accordingly, in embodiments where a user is identified as an unapproved accessor, a processor may prompt the user to perform one or more actions associated with the one or more security rules of the security policy the user needs to perform in order for the user to be identified as an approved accessor. In these embodiments, after the user has performed the one or more actions, the processor may reevaluate the user to re-determine if the user is an approved accessor or unapproved accessor (e.g., determine whether the impact level activates the safety threshold).

A more robust discussion of the various embodiments contemplated above are now provide. In embodiments, a processor may collect or receive environment information from a smart environment. A smart environment may include any environment or bounded area such as, a workplace (e.g., laboratory, mine, hospital, etc.), vehicles (e.g., tractor trailers, cars, busses, etc.), any other type of setting (e.g., warehouse, a particular room, set of rooms, house, office building, grocery store, shopping mall, conference room, etc.), or any combination thereof. While embodiments contemplate herein often refer to a smart environment as a workspace, such embodiments are used for example only and should not be construed as limiting.

The processor may configure one or more data collection devices to communicate within a network. The one or more devices may be configured within and/or around the smart environment to share and provide the processor with environment information. In embodiments, a smart environment may include any number or combination of one or more data collection devices. The data collection devices may include, but are not limited to devices such as, Internet of Things (IoT) devices, cameras, infrared sensors, ultrasounds, chemical sensors, wearable devices (e.g., device worn into the smart environment by a user), various types of smart device (e.g., AI assistant devices), or any combination thereof. Data collection devices may be configured by a processor to receive/collect environment information in real-time and/or to collect environment information over a particular time duration. Such environment information may be stored in a historical repository and accessed as needed by the processor (e.g., when performing analyses using AI and machine learning capabilities). While some data collections may be configured within the smart environment, other data collection devices may be configured outside and/or around the smart environment. For example, some data collection devices may be wearable devices configured on a user, while other data collection devices may be positioned directly outside the smart environment (e.g., at the entrance of the smart environment) to collect environment information associated with the user.

Environment information may include any data or information associated with the smart environment and managing user access to the smart environment. For example, environment information may include any data derived from within the smart environment, around the smart environment (e.g., the entrance and/or surrounding area of the smart environment), and data associated with all or less than all of the users intending to access the smart environment. Environment information may include, but is not limited to: i) the configuration of the smart environment (e.g., workplace layout and/or dimensions), ii) what objects (e.g., users, equipment, chemicals, etc.) may currently occupy the smart environment, iii) location of each object (e.g., real-time location) within the smart environment, iv) user activity within the smart environment such as how the users performs tasks in the smart environment (e.g., potential problems or accidents, equipment use, user actions, etc.), v) amount and/or type of resource consumption (e.g., resource consumption resulting from the smart environment and/or user resource consumption) consumed within the smart environment, vi) information/data generated from various analyses contemplated herein (e.g., information/data generated by AI and machine learning analysis), vii), and databases having information/data associated with the same or similar smart environments (e.g., common environment conditions, such as hazards that may transpire among similarly configured smart environments).

In embodiments where a processor accesses a database, a processor could receive environment information from the database regarding particular parameters and configurations of specific smart environment types. In an example embodiment where the smart environment is a mine, a processor may access an external database having information associated with how particular weather patterns (e.g., rainfall, temperature changes, etc.) may result in changes in environment conditions within the mine and/or how those environment conditions may impact miners' (e.g., users') and their activities within the mine.

A processor may store historical environment information in a historical repository. Historical environment information may include any environment information contemplated herein, such as that associated with the one or more users and/or various user activity (e.g., user communications, user movement within the smart environment, work related activities, etc.) performed within the smart environment. In embodiments, a processor may access the historical repository to perform analyses using AI and machine learning capabilities. The information generated from these analyses may be considered environment information and may also be stored within the historical repository.

In embodiments, a processor may access and analyze environment information from the historical repository using AI and natural language processing (NLP) capabilities to generate a knowledge corpus. In these embodiments, a processor may use the generated knowledge corpus to analyze and identify (e.g., using NLP capabilities) different aspects of the smart environment and/or user, such as those contemplated herein. For example, in some embodiments, a processor may analyze and determine if one or more new types of data collection devices (e.g., new market released IoT devices) may be configured within the smart environment that is consistent with the various embodiments contemplated herein. In these embodiments, a processor may generate and use a knowledge corpus to autonomously determine if the new one or more data collection devices can be incorporated into the smart environment. For example, a new, state of the art, device may enable a more accurate generation of updated security rules or new security policies.

In embodiments, a processor may analyze environment information collected/received from one or more data collection devices to determine if a user intends to enter/access the smart environment. For example, a processor may observe a miner (e.g., user) approaching the entrance to a mine configured with one or more data collection devices (e.g., smart environment). In this example, the processor could be configured to receive environment information associated with the miner (e.g., from a wearable device), such as the location of the miner or direction in which he is traveling. In some embodiments, a processor may access the miner's work schedule to determine if and when the miner is scheduled to work, to identify whether the miner intends to enter the mine.

In embodiments, a processor may analyze environment information associated with the smart environment. As contemplated herein, a processor may be configured to receive a real-time feed of the smart environment (e.g., via data collection devices). This environment information may be used to identify one or more environment conditions associated with the current status of the smart environment. An environment condition may be any circumstance or situation occurring or potentially occurring within the smart environment that may impact a user in the smart environment. While in some embodiments, a processor may analyze environment information and identify an environment condition currently affecting the smart environment, in other embodiments, a processor may analyze environment information to predict a possible future occurring environment condition that may impact the user while they are occupying the smart environment. In these embodiments, a processor may be configured with AI and machine learning capabilities to generate one or more simulations, using historical environment information, to identify if a particular environment condition may occur. For example, in a mine (e.g., smart environment) a processor may receive environment information indicating heavy rainfall is occurring. In this example, the processor may simulate the mine and determine if the heavy rainfall is likely to penetrate the various mining tunnels, wherein moisture may accumulate, and if any portion of the mining tunnel may be at risk for flooding.

In some embodiments, a processor may generate the various simulations contemplated herein using AI enhanced digital twin technology. In such embodiments, a processor may use environment information and data/information from the historical repository (e.g., historical environment information) to produce one or more digital twins of the smart environment to simulate various interactions associated with the user and the smart environment. For example, a processor may use these digital twins to generate simulations (e.g., AI and machine learning techniques) associated with how the environment condition may affect the user (e.g., the impact level). In some embodiments, a processor may analyze environment information associated with the sources of success and failure parameters related to the user's activities in the smart environment. This information may be used to identify environment conditions and/or used to generate new security rules, such as those security rules needed to reduce the impact of new environment conditions. In some embodiments, a processor may analyze historical environment information from the historical repository to identify and/or classify possible environment conditions, such as accidents, hazards, potential problems within the smart environment, user difficulties in the smart environment, etc. In some embodiments, a processor may identify types of user difficulties using information associated with user feedback and/or smart environment information.

In embodiments where an environment condition (e.g., currently occurring and/or potentially occurring environment condition) is identified in the smart environment, a processor may compare the environment condition to the security policy. A security policy may include one or more security rules that aim to secure and safeguard the user and/or the smart environment. In embodiments, a security policy may include one or more security rules that may be directly associated with a particular environment condition and/or generally associated with the smart environment. For example, a security policy may include a security rule requiring a user entering a construction site to wear a helmet whenever the user is in the smart environment, but if a particular construction process (e.g., environment condition) is occurring on a particular day that may pose a risk to the user, there may be a security rule that relates directly to that construction process. Security rules may include information associated an impact level that indicates how a user may be impacted or affected by the particular environment condition, requirements or guidelines regarding how those users may reduce the effect of the environment condition, and a safety threshold indicating the maximum amount of risk or impact level a user may assume when entering the smart environment.

The impact level may indicate the risk or negative effects a user may be exposed to upon entering the environment with a particular environment condition. While a high impact level may indicate the environment condition may significantly affect the user or pose a risk to the user's health and safety (e.g., risk of dehydration, tripping, or becoming lost in unlit areas), a low impact level may indicate a small effect to the user or not pose a risk to the user's health and safety (e.g., a slight decrease or increase in temperature degrees from standard room temperature). Though in some embodiments a processor may be configured to receive the security policy (e.g., the impact level, safety threshold, and other security rules) from an administrator dictating what security rules should be followed, in other embodiments, a processor may configure the security policy using various simulation methods, such as those contemplated herein. While in some embodiments, a processor may generate a particular safety threshold for each smart environment that remains consistent regardless of the environment condition, in other embodiments, a processor may generate a safety threshold for each environment condition associated with a particular smart environment.

Examples of one or more security rules, such as those relating to how users may reduce the effect of the environment condition, include, but are not limited to, i) health and safety regulations, such as those requiring users to utilize personal protective equipment (e.g., masks, goggles, headlamp, lab coat, etc.); ii) amount and type of additional consumable resources a user may need to carry into the smart environment, such as those that may be needed and consumed while the user is performing activities within the smart environment (e.g., extra batteries or extra water); and iii) one or more actions that should be performed by the user prior to the user entering the smart environment (e.g., the user may be required to turn on a piece of equipment before entering the smart environment). For example, in embodiments where the user is a miner who works in a mine, a security policy may include one or more security rules, such as requiring a miner to wear a helmet with a headlamp, to keep a flashlight on their person, to maintain on their person extra water and/or batteries, and to have a communication device (e.g., wireless microphone) that may be used within the smart environment.

In embodiments, a processor may continuously receive environment information to identify if there are any environment conditions occurring or potentially occurring within the smart environment that may impact the user. In embodiments where an environment condition has been identified, a processor my analyze the security policy to determine if there are one or more security rules that are associated with the particular environment condition. In embodiments where processor determines there are one or more security rules associated with the environment condition, a processor may access and interpret the one or more security rules. While in some embodiments one or more security rules may include an impact level and/or safety threshold, in other embodiments, a processor may determine an impact level and/or safety threshold by simulating the effect or impact the environment condition may have on the user. Such embodiments may be performed by analyzing environment information and historical environment information using AI and machine learning techniques (e.g., AI enabled digital twin technology). In embodiments, a processor may also simulate one or more security rules associated with how the impact level may be reduced (e.g., by wearing personal protective equipment).

In embodiments, a processor may evaluate a user's attributes (e.g., via environment information), prior to the user entering the smart environment, to identify whether the user as an approved accessor or an unapproved accessor. The processor may identify one or more security rules associated with the one or more environment conditions occurring or potentially occurring within the smart environment. While users identified as an approved accessor may be granted access to the smart environment, users identified as an unapproved accessor are prevented from accessing the smart environment. A processor may be configured to identify a user as an approved accessor or an unapproved accessor based, at least in part, on whether or not the impact level activates the safety threshold associated with a particular environment conditions. As disclosed herein, a safety threshold may indicate a maximum amount of allotted risk (e.g., impact level), associated with a particular environment condition, a user may undertake when entering/accessing a smart environment. In embodiments where a processor determines the impact level does not activate (e.g., does not meet and/or exceed) the safety threshold, a processor may identify the user as an approved accessor and grant the user access to the smart environment. If a processor determines the impact level for the user activates (e.g., meets and/or exceeds) a safety threshold, a processor will identify the user as an unapproved accessor and prevent the user from accessing the smart environment.

In some embodiments, a processor may reduce the impact level associated with a particular environment condition based, at least in part, on environment information associated with the user. For example, the effect or impact of the environment condition (e.g., impact level) on a user may be reduced or mitigated if the user preforms or has performed one or more actions. In such embodiments, the one or more actions may be associated with the one or more security rules of the security policy. During user evaluation, a processor may receive environment information associated with the user and determine if the user has performed or addressed the one or more actions associated with the one or more security rules.

In one example embodiment, a processor may analyze a machine shop (e.g., smart environment) and identify possible projectile metal shavings, resulting from various machining processes, as an environment condition. In such an embodiment, a processor may analyze the security policy and identify security rules associated with this particular environment condition. These security rules may include the possible impact level associated with the impact projectile metal shavings may have on a user, the safety threshold associated with the maximum amount of risk the user may undertake when entering the machine shop, and a security rule indicating that a user intending to enter the machine shop should wear protective eyewear into the machine shop to protect against possible projectile metal shavings. Continuing this example, the processor may identify and evaluate a user intending to access the machine shop. During this evaluation, the processor may collect/receive environment information associated with the user. This environment information may include data associated with what the user may be wearing or carrying on their person.

The processor may then evaluate the user to determine if the impact level (e.g., risk to user) activates or does not activate the safety threshold. The impact level may activate the safety threshold if the impact level meets and/or exceeds the safety threshold. In embodiments, the impact level, or risk to user in the smart environment, may be mitigated by addressing one or more of the security rules associated how the effects of the environment condition on the user may be reduced. Continuing the above example with a user intending to enter a machine shop, a processor may be configured to receive environment information (e.g., using data collection devices) associated with the user intending to access the machine shop. The processor may identify that this particular user may be wearing a particular type of helmet, carrying extra water, and wearing reading glasses. In some embodiments, a processor may analyze this environment information associated with the user and determine that the user has satisfied the security rule. For example, the processor may determine that reading glasses observed on the user provide the same amount of protection as required by the security rule requiring the user to wear protective eyewear into the machine shop (e.g., to protect against possible projectile metal shavings). In embodiments where a processor determines that a security rule is satisfied by the user, the processor may reduce the impact level (e.g., as dictated by the security policy). In this example, the processor may reduce the impact level because the processor has identified that the reading glasses provide the same level of protection as indicated in the security rule. The processor may then determine if the now reduced impact level meets or exceeds the safety threshold. Because the impact level has been reduced in such a way that satisfies the one or more security rules (e.g., as determined by the processor), the processor may determine that the safety threshold is not activated for the particular condition. Continuing the above example, the processor may determine that the user's use of reading glasses reduces the impact level or risk associated with potential projectile metal shavings in the machine shop to a level that does not activate the safety threshold. In embodiments where the processor determines that the safety threshold has not been activated, a processor may identify the user as an approved accessor and allow the user to access the smart environment. As such, the processor would identify the user intending to enter the machine shop as an approved user and allow the user to access the machine shop.

In some embodiments, a processor may determine the impact level associated with a particular environment condition's impact on the user is not reduced. For example, using a slight fact pattern alteration of the above example embodiment, a processor may receive environment information associated with a user indicating that the user is wearing reading glasses (e.g., environment information) and intending to enter a machine shop where the user may be impacted by projectile metal shavings resulting from machine use. In this example, the processor may analyze the security policy and identify the following security rules: an impact level associated with possible projectile metal shavings, a rule requiring the user to wear protective eyewear into the machine shop (e.g., to protect against possible projectile metal shavings), and a safety threshold. The processor may determine that while the user is wearing reading glasses that may result in some or partial eye protection and may marginally reduce the impact level of the environment condition on the user, the impact level maintains a level that still meets/exceeds (e.g., activates) the safety threshold. In embodiments where a processor determines that the impact level activates the safety threshold (e.g., after evaluation), the processor may identify the user as an unapproved accessor and prevent the user from accessing/entering the smart environment. As such, the user attempting to enter the machine shop would be identified as an unapproved accessor and would not be allowed to access the smart environment.

In embodiments where a processor has identified a user as an unapproved accessor, a processor may issue one or more prompts or notifications to the user. These prompts or notifications may include one or more actions that, if performed by the user, may satisfy a particular security rule associated with a particular environment condition to reduce the impact level on the user. For example, the processor may issue a prompt to the user indicating the user should put on protective goggles (e.g., one or more actions) in order to satisfy a security rule requiring the user to wear protective eyewear into the machine shop.

In embodiments, a user's attributes (e.g., environment information associated with what equipment the user is wearing, such as helmet, flashlight, etc.) may be reevaluated by the processor. The processor may determine if the user followed one or more action in the one or more prompts. In embodiments, where a processor has determined a user has followed the one or more actions (e.g., put on protective goggles or a mask) a processor may determine that the impact level is reduced and does not activate the safety threshold. A processor may then identify the reevaluated user as an approved accessor and allow the user to enter/access the smart environment. Alternatively, if a processor reevaluates the user and determines the user has not adhered to or followed the one or more actions in the prompt, the processor may determine the impact level will activate the safety threshold. In embodiments where the processor determines the safety threshold is activated, the reevaluated user will continue to be identified as an unapproved accessor and prevented from entering/accessing the smart environment. While embodiments contemplated herein often refer to a processor managing access to a smart environment based on a single environment condition a processor may manage access to a smart environment having any number of environment conditions.

In some embodiments, a processor may identify one or more environment conditions associated with the smart environment (e.g., using environment information) that may have an impact on the user. In some embodiments, these environment conditions may be novel environment conditions that have not occurred in the smart environment. Because of this, the security policy may not include security rules associated with the environment condition. In these embodiments, a processor may determine that the security policy, and its associated one or more security rules, does not reduce the possible impact (e.g., impact level) associated with the new or novel environment condition on the user.

In embodiments, a processor may generate a new security rule configured to reduce the impact level associated with the user. A processor may form a new security rule by generating one or more simulations using AI and machining techniques to analyze environment information and historical environment information from the historical repository. The generated simulations (e.g., digital twins of the user and smart environment) may be used to determine, more particularly, how a user may be impacted or affected by the environment condition (e.g., impact level), as well as how the impact or effect to the user may be mitigated (e.g., wearing personal protective equipment into the smart environment). Once the security rule has been proofed using the one or more simulations, a processor may update the security policy with the new security rule. In these embodiments, a processor may then apply the new security rule of the security policy to a user intending to enter the smart environment.

In some embodiments, a processor may perform one or more audits of the security policy and associated security rules. In these embodiments, a processor may identify if one security rule of the one or more security rules, such as those associated with a particular environment condition, fails to reduce the impact level associated with the particular environment condition on a user, even in situations where the user adheres to the security rule. In these embodiments, a processor may remove the one security rule, that no longer reduces or mitigates the risk to the user posed by the environment condition, of the one or more security rules included in the security policy.

In some embodiments, a processor may analyze environment information associated with users performing various activities in the smart environment. From this analysis, a processor may identify how the users are consuming resources within the smart environment. In these embodiments, a processor may be configured to identify various circumstances associated with user resource consumption during the duration of time a user is performing a particular activity in smart environment. These various circumstances may include, but are not limited to, identifying why the user is consuming their supply of resource (e.g., why is the user consuming their water supply), why is the user utilizing the resource in a particular manner or pattern (e.g., the user is using a flashlight with a limited battery life for prolonged periods of time). In some embodiments, a processor may determine whether the smart environment may be configured to provide or supply one or more of the consumable resources to the users. While in some embodiments, a processor may identify natural sources of consumable resource within the smart environment (e.g., a mine has a water well configured to provide miners with fresh water to consume) in other embodiments, a processor may identify where consumable resources may be stored within the smart environment to provide users with easy access to the resource without the user being required to carry the consumable resource on their person into the smart environment.

In embodiments where a processor determines the smart environment is unable to supply the user's consumable resource needs, a processor may update the security policy with a new security rule that may require the user to carry a particular amount of the consumable resource (e.g., to reduce or mitigate an impact level associated with a particular environment condition). For example, the new security rule may indicate that a user may be required to have an additional two battery packs (e.g., consumable resources) that they may be required to carry into the smart environment in order to be identified as an approved accessor (e.g., impact level does not activate the safety threshold) and granted access to the smart environment. In some embodiments, a processor may analyze smart environment information to identify single user consumption and multi-user consumption. This information may also be used to generate new security rules as needed based on such.

In some embodiments, a smart environment may be a vehicle (e.g., a car, mobile home, etc.). In one example embodiment, historical environment information may be analyzed to indicate that if the user is intending to drive (e.g., a processor determines the user is walking towards the driver side of the vehicle) the user will require corrective eyeglasses to perform any driving. The processor may send a prompt or notification to a user reminding the user to collect and wear their corrective eyeglasses. In these embodiments, the processor may prevent a user (e.g., unapproved accessor) from occupying and/or operating the vehicle. Such embodiments prevent the user from creating a hazard by driving visually impaired without their glasses. In some embodiments, a processor may receive notice from the user indicating the user is wearing contact lenses and the user may then be identified as an approved accessor. In some embodiments, a processor may use AI and machine learning to analyze historical environment information associated with one or more users performing various activities or tasks within the smart environment. In these embodiments, a processor may identify various skills and skill levels associated with one or more particular users (e.g., a user only know how to operate one device out of twenty devices in the smart environment). In embodiments, a processor may identify an environment condition and associated one or more security rules associated with reducing the impact or risk to the user. In these embodiments, a processor may identify a security rule from the security policy that requires the user to have a particular skill in order to mitigate their risk when entering the smart environment. If the processor determines (e.g., using environment information) that the user does not have this particular skill as required by the security rule, the processor may determine the user is an unapproved accessor and prevent them from entering the smart environment (e.g., the user's lack of a particular skill activates the safety threshold).

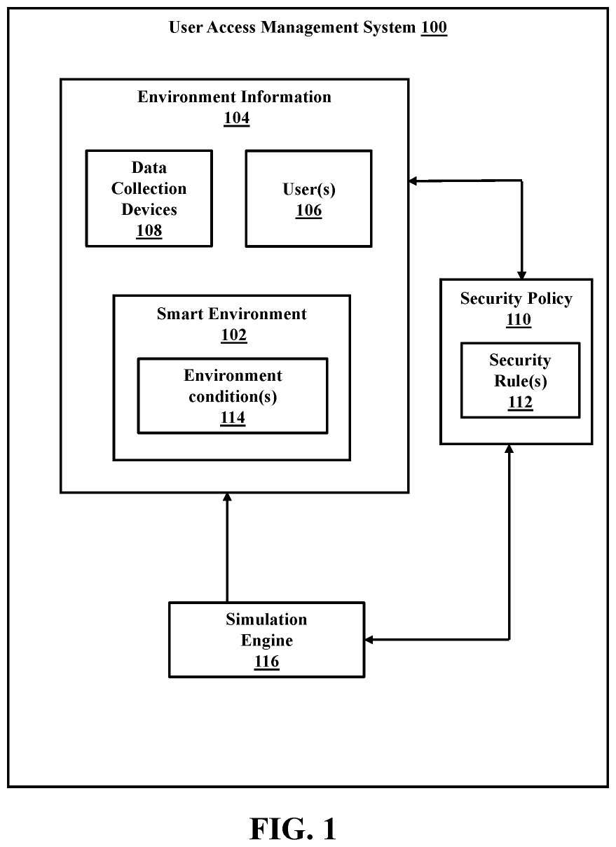

Referring now to FIG. 1, a block diagram of user access management system 100 for managing use access to a smart environment is depicted, in accordance with embodiments of the present disclosure. FIG. 1 provides an illustration of only one implementation and does not imply any limitations with regard to the environments in which different embodiments may be implemented. Many modifications to the depicted environment may be made by those skilled in the art without departing from the scope of the invention as recited by the claims.

In embodiments, user access management system 100 may be configured to manage user access to smart environment 102. In embodiments, user access management system 100 may collect environment information 104. Environment information 104 may include data associated with one or more user(s) 106 and smart environment 102. Environment information may be collected from one or more data collection devices 108 from inside smart environment 102, the area surrounding smart environment 102 (e.g., the access point where user 106 may enter), and/or from user 106 via one or more data collections devices 108 associated with user 106, such as wearable devices that may be worn by user 106.

In embodiments, user access management system 100 may be configured to analyze environment information 104 and/or security policy 110 having one or more security rule(s) 112. In these embodiments, user access management system 100 may be configured to identify one or more environment condition(s) 114 associated with smart environment 102 that may be currently occurring in smart environment 102 or may occur in smart environment 102. User access management system 100 may then determine the impact level of the one or more environment conditions 114 on user 106. In embodiments, security policy 110 may have one or more security rules 112 that may include rules associated with environment condition 114 regarding how user 106 may be impacted by the environment condition 114 and how the impact to user 106 may be reduced.

In embodiments, user access management system may be configured to evaluate user 106 based on the impact level and the security policy 110 (or security rules 112) using simulation engine 116. In some embodiments, user access management system 100 may be configured to use AI and machine learning capabilities to determine whether the impact level associated with the user (e.g., using environment information 104) activates or does not activate a safety threshold as indicated in security policy 110. In embodiments where user access management system 100 determines the impact level associated with the user activates the safety threshold, the user may be identified as an unapproved accessor and prevented from accessing smart environment 102. In embodiments where user access management system 100 determines the impact level associated with the user does not activate the safety threshold, the user may be identified as an approved accessor and granted the ability to access/enter smart environment 102.

In some embodiments, user access management system 100 may be configured to update security policy 110 with one or more security rules 112 (e.g., new security rules). In embodiments, simulation engine 116 may be configured to generate one or more simulations to verify the new security rule reduces the impact level or how environment condition 114 may affect user 106. In embodiments where simulation 116 verifies the new security rule, user access management system 100 may be configured to update security policy 110 with the new security rule. In some embodiments, simulation engine 116 may use environment information 104 to determine that a security rule of the one or more security rules 112 of the security policy 110 no longer mitigates or reduces the impact level of environment condition 114. In these embodiments, user access management system may be configured to remove the security rule that no longer reduces the impact level on user 106 from security policy 110.

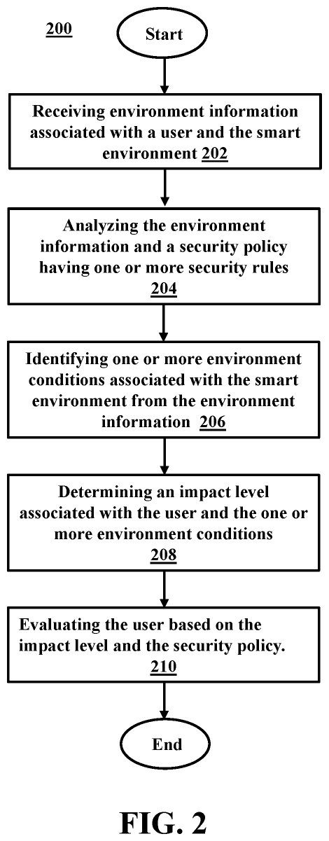

Referring now to FIG. 2, a flowchart illustrating an example method 200 for managing user access in a smart environment, in accordance with embodiments of the present disclosure. FIG. 2 provides an illustration of only one implementation and does not imply any limitations with regard to the environments in which different embodiments may be implemented. Many modifications to the depicted environment may be made by those skilled in the art without departing from the scope of the invention as recited by the claims.

In some embodiments, the method 200 begins at operation 202 where a processor may receive environment information associated with a user and the smart environment. In some embodiments, the method 200 proceeds to operation 204.

At operation 204, a processor may analyze the environment information and a security policy having one or more security rules. In some embodiments, the method 200 proceeds to operation 206.

At operation 206, a processor may identify one or more environment conditions associated with the smart environment from the environment information. In some embodiments, the method 200 proceeds to operation 208.

At operation 208, a processor may determine an impact level associated with the user and the one or more environment conditions. In some embodiments, the method 200 proceeds to operation 210.

At operation 210, a processor may evaluate the user based on the impact level and the security policy. In some embodiments, as depicted in FIG. 2, after operation 208, the method 200 may end.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

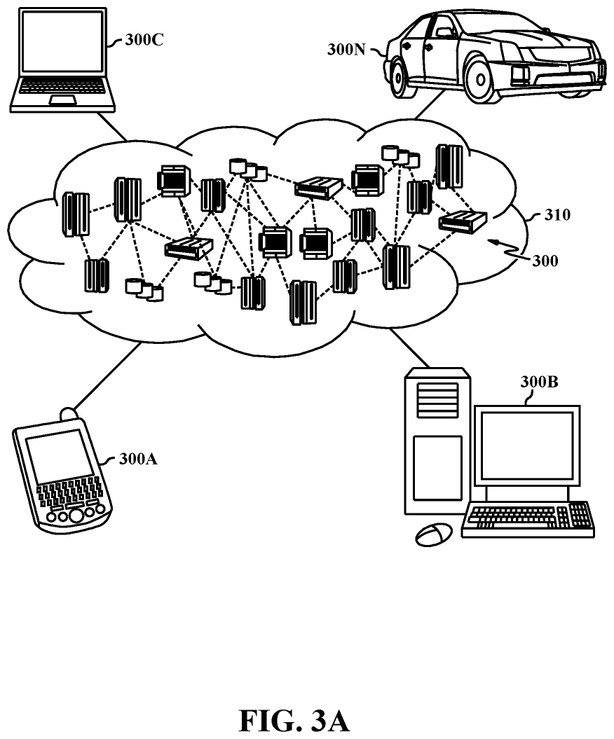

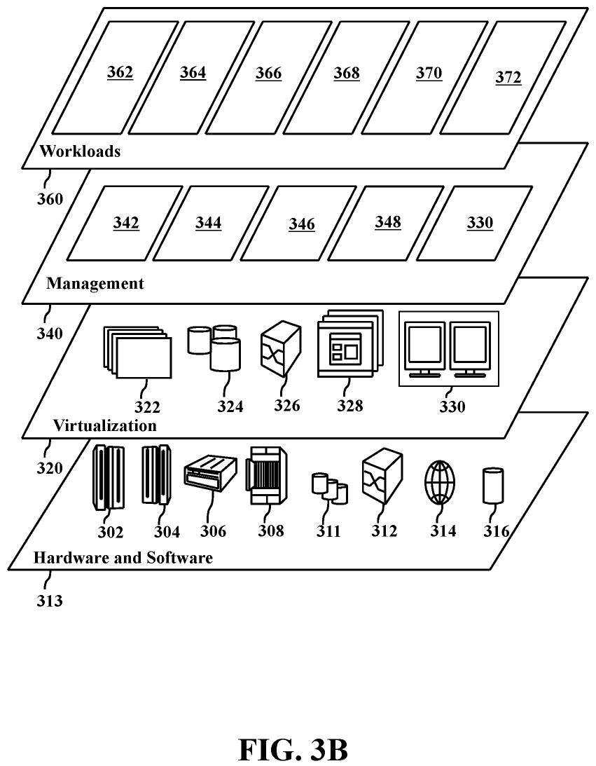

Referring now to FIG. 3A, illustrative cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof. This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing 300 and cloud computing environment 310 can communicate with any type of computerized device over any type of network and/or network addressable connection (e.g., using a web browser).

Referring now to FIG. 3B, a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and user access managing 372.

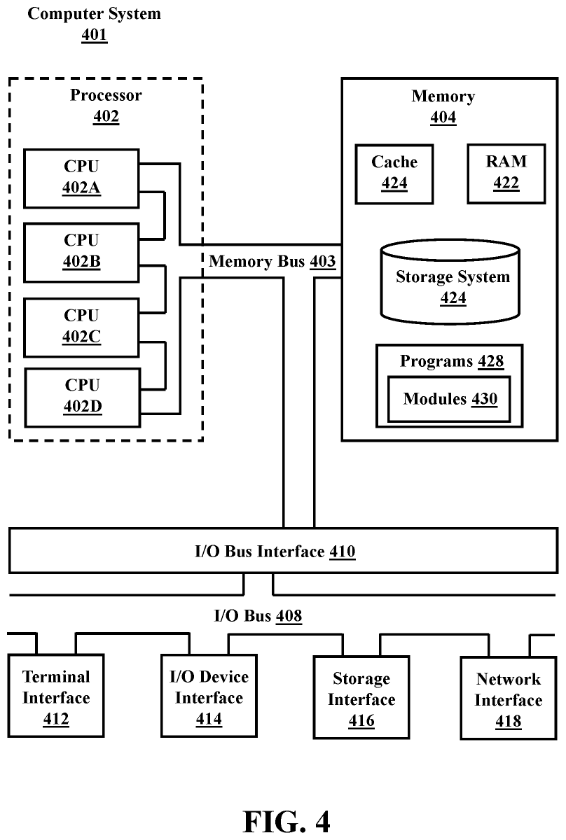

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present invention. In some embodiments, the major components of the computer system 401 may comprise one or more Processor 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for managing user access to a smart environment, comprising:
receive, via a processor, environment information associated with a user and the smart environment;
analyzing the environment information and a security policy having one or more security rules;
identifying one or more environment conditions associated with the smart environment from the environment information;
determining an impact level associated with the user and the one or more environment conditions; and
evaluating user attributes of the user, based on the impact level and the security policy.

2. The method of claim 1, wherein evaluating the user includes:
determining that the impact level associated with the user activates a safety threshold, wherein the safety threshold is determined by the security policy;
identifying that, responsive to the impact level activating the safety threshold, the user is an unapproved accessor; and
preventing the unapproved accessor from accessing the smart environment.

3. The method of claim 2, further including:
prompting the user to perform one or more actions associated with the security policy; and
reevaluating the user attributes of the user based on the impact level and the security policy.

4. The method of claim 1, wherein evaluating the user includes:
determining that the impact level associated with the user does not activate a safety threshold, wherein the safety threshold is determined by the security policy;
identifying that, responsive to determining the impact level does not activate the safety threshold, the user is an approved accessor; and
granting the approved accessor access to the smart environment.

5. The method of claim 1, further comprising:
determining that the security policy does not reduce the impact level associated with the user.

6. The method of claim 5, further including:
generating a new security rule for the security policy, wherein the new security rule reduces the impact level associated with the user;
simulating the new security rule in the smart environment; and
updating, based on simulating the new security rule, the security policy with the new security rule.

7. The method of claim 5, further including:
identifying that one security rule of the one or more security rules of the security policy does not reduce the impact level; and
removing the one security rule of the one or more security rules from the security policy.

8. A system for managing user access to a smart environment, the system comprising:
a memory; and
a processor in communication with the memory, the processor being configured to perform operations comprising:
receive environment information associated with a user and the smart environment;
analyzing the environment information and a security policy having one or more security rules;
identifying one or more environment conditions associated with the smart environment from the environment information;
determining an impact level associated with the user and the one or more environment conditions; and
evaluating user attributes of the user, based on the impact level and the security policy.

9. The system of claim 8, wherein evaluating the user includes:
determining that the impact level associated with the user activates a safety threshold, wherein the safety threshold is determined by the security policy;
identifying that, responsive to the impact level activating the safety threshold, the user is an unapproved accessor; and
preventing the unapproved accessor from accessing the smart environment.

10. The system of claim 9, further including:
prompting the user to perform one or more actions associated with the security policy; and
reevaluating the user attributes of the user based on the impact level and the security policy.

11. The system of claim 8, wherein evaluating the user includes:
determining that the impact level associated with the user does not activate a safety threshold, wherein the safety threshold is determined by the security policy;
identifying that, responsive to determining the impact level does not activate the safety threshold, the user is an approved accessor; and
granting the approved accessor access to the smart environment.

12. The system of claim 8, further comprising:
determining that the security policy does not reduce the impact level associated with the user.

13. The system of claim 12, further including:
generating a new security rule for the security policy, wherein the new security rule reduces the impact level associated with the user;
simulating the new security rule in the smart environment; and
updating, based on simulating the new security rule, the security policy with the new security rule.

14. The system of claim 12, further including:
identifying that one security rule of the one or more security rules of the security policy does not reduce the impact level; and
removing the one security rule of the one or more security rules from the security policy.

15. A computer program product for managing user access to a smart environment comprising a computer readable storage medium having program instructions embodied therewith, the program instructions executable by a processor to cause the processor to perform operations, the operations comprising:
receive environment information associated with a user and the smart environment;
analyzing the environment information and a security policy having one or more security rules;
identifying one or more environment conditions associated with the smart environment from the environment information;
determining an impact level associated with the user and the one or more environment conditions; and
evaluating user attributes of the user, based on the impact level and the security policy.

16. The computer program product of claim 15, wherein evaluating the user includes:
determining that the impact level associated with the user activates a safety threshold, wherein the safety threshold is determined by the security policy;
identifying that, responsive to the impact level activating the safety threshold, the user is an unapproved accessor; and
preventing the unapproved accessor from accessing the smart environment.

17. The computer program product of claim 16, further including:
prompting the user to perform one or more actions associated with the security policy; and
reevaluating the user attributes of the user based on the impact level and the security policy.

18. The computer program product of claim 15, wherein evaluating the user includes:
determining that the impact level associated with the user does not activate a safety threshold, wherein the safety threshold is determined by the security policy;
identifying that, responsive to determining the impact level does not activate the safety threshold, the user is an approved accessor; and
granting the approved accessor access to the smart environment.

19. The computer program product of claim 15, further comprising:
determining that the security policy does not reduce the impact level associated with the user.

20. The computer program product of claim 19, further including:
generating a new security rule for the security policy, wherein the new security rule reduces the impact level associated with the user;
simulating the new security rule in the smart environment; and
updating, based on simulating the new security rule, the security policy with the new security rule.
